(19) United States
(12) Patent Application Publication
(10) Pub. No.: US 2025/0001710 A1
(43) Pub. Date: Jan. 2, 2025

(54) METHOD FOR INJECTING RESIN AND DEVICE FOR HOLDING A FIBER TEXTURE ON AN IMPREGNATION MANDREL OF A WINDING MACHINE

(71) Applicant: SAFRAN AIRCRAFT ENGINES, Paris (FR)

(72) Inventors: Hubert Jean Marie FABRE, Moissy-Cramayel (FR); Maxime GUILLOT, Moissy-Cramayel (FR)

(73) Assignee: SAFRAN AIRCRAFT ENGINES, Paris (FR)

(21) Appl. No.: 18/708,475

(22) PCT Filed: Nov. 9, 2022
(86) PCT No.: PCT/EP2022/081216

§ 371 Date: May 8, 2024

Related U.S. Application Data
(60) Provisional application No. 63/277,307, filed on Nov. 9, 2021.

(51) Int. Cl. B29C 70/54; B29C 70/32; B29C 70/44; B29L 31/00

(52) U.S. Cl. CPC B29C 70/541; B29C 70/32; B29C 70/443; B29C 2793/009; B29L 2031/7504

(57) ABSTRACT

A method for injecting an impregnation resin for the manufacture of a revolution part made of composite material in which several clamping blocks are bearing on a fiber texture wound on an impregnation mandrel forming an injection mold for its holding during the cutting of the last layer of the fiber texture in an end-of-winding position, the fiber texture being heated before the removal of the clamping blocks and the closing of the mold to inject the impregnation resin therein.

### BACKGROUND OF THE INVENTION

The present invention relates to the general field of the production of gas turbine casings made of composite material, and more particularly of retention casings for a gas turbine fan for aeronautical engines.

In an aeronautical gas turbine engine, a fan casing performs several functions: it defines the air inlet flow section for the flow of air into the engine, supports an abradable material facing the tip of the fan blades, supports a possible sound wave absorbing structure for the acoustic treatment at the inlet to the engine and incorporates or supports a retention shield. The latter constitutes a trap retaining the debris, such as ingested objects or fragments of damaged blades, projected by centrifugation, so as to prevent them from passing through the casing and reaching other portions of the aircraft.

The production of a fan casing made of composite material is known per se. Reference may for example be made to document EP 1 961 923 which describes the manufacture of a casing made of composite material with varying thickness comprising the formation of a fiber reinforcement by superimposed layers of a fiber texture and the densification of the fiber reinforcement by a polymer matrix. More specifically, this document provides using a drum (hereinafter called storage mandrel) for the three-dimensional weaving of the fiber texture, the latter then being wound in superimposed layers on the mandrel of a resin injection mold (hereinafter called impregnation mandrel) having an external surface whose profile corresponds to that of the central portion of the casing to be manufactured and two side flanges corresponding to fastening clamps of the casing. The fiber preform thus obtained being held on the impregnation mandrel, an impregnation is then carried out with a resin. To this end, an envelope forming a counter-mold is applied on the fiber preform and the resin is injected into the closed assembly thus constituted by this envelope and the impregnation mandrel. The impregnation can be assisted by establishing a pressure difference between the interior and the exterior of the mold in which the fiber preform is located. After impregnation, a step of polymerizing the resin by heating the mold is carried out. The part finally obtained can then be unmolded and trimmed to remove excess resin and form the desired casing.

With such an embodiment, there is the problem of holding the fiber texture on the impregnation mandrel at the start of winding but also and especially at the end of winding where, before being cut to its final length and being impregnated with resin, the fiber preform must be held while avoiding losing the tension applied to the texture during its winding.

The application EP 2 771 172 has solved this problem of holding the fiber texture on the impregnation mandrel at the start and at the end of winding by proposing a removable device fastened on the side flanges of the impregnation mandrel of the winding machine and which is provided with blocks intended to bear against the central portions and ends of the fiber texture and on which a clamping (or pinching) force is exerted to hold the layer of fiber texture wound on the impregnation mandrel.

However, at the end of winding, during the removal of the blocks and the closing of the counter-molds prior to the injection of the resin, a slip is created at the outer or upper layer, the last layer of the fiber texture which by leaving a cavity in the closed mold, will create a resin-rich area likely to lead to a rejection of the final part once unmolded.

### OBJECT AND SUMMARY OF THE INVENTION

The main aim of the present invention is therefore to overcome the aforementioned drawback by proposing an improved resin injection method associated with a holding device which prevents any displacement of the preform prior to the closing of the injection mold. One aim of the invention is also to ensure better adhesion between the layers of the fiber texture. Another aim is to allow better control of the dimensions and weight of the preform.

These aims are achieved by a method for injecting an impregnation resin for the manufacture of a revolution part made of composite material in which several clamping blocks are bearing on a fiber texture wound on an impregnation mandrel forming an injection mold for its holding during the cutting of the last layer of the fiber texture in an end-of-winding position, characterized in that the fiber texture is heated before the removal of the clamping blocks and the closing of the mold to inject the impregnation resin therein.

Thus, by heating the fiber texture before the closing of the mold, this fiber texture is stiffened and is allowed to adhere to the previous winding turn. The absence of slip further allows optimizing the cutting and therefore better controlling the weight of the preform.

Preferably, a thin layer of the impregnation resin is applied on the fiber texture before the bearing of the clamping blocks and the heating of the fiber texture.

Advantageously, the thin layer of the impregnation resin is applied by spraying or whitewash.

Preferably, the percentage of applied impregnation resin represents less than 3% of the total of the impregnation resin injected into the mold.

In one particular embodiment, the closing of the mold is preceded by the installation of a compaction membrane.

The invention also relates to a device for holding a fiber texture on an impregnation mandrel forming an injection mold, comprising:
a cross-member forming a support, each end of which is intended to be fastened on one of the side flanges of the impregnation mandrel;
at least one central block holder mounted on the cross-member and provided with a front clamping block and at least one side block holder mounted on the cross-member and provided with at least one side clamping block; characterized in that it further comprises:
a heating pad interposed between each front clamping block and the layer of fiber texture wound on the impregnation mandrel; and
means for exerting a clamping force of the front clamping blocks on the layer of fiber texture wound on the impregnation mandrel via the heating pads.

Advantageously, the holding device further comprises a spraying module intended to spray a thin layer of the impregnation resin onto the fiber texture, before the bearing of the clamping blocks and the heating of the fiber texture by the heating pads.

Preferably, the heating pads and the front clamping blocks form one and the same part.

Advantageously, the holding device further comprises a compaction membrane disposed on the layer of fiber texture before the closing of its mold.

Finally, the invention relates to a winding machine including an impregnation mandrel on which the fiber texture stored on a storage mandrel is intended to be wound in superimposed layers, and at least one holding device as mentioned above.

### BRIEF DESCRIPTION OF THE DRAWINGS

Other characteristics and advantages of the present invention will emerge from the description given below, with reference to the appended drawings which illustrate an exemplary embodiment thereof without any limiting nature. In the figures:

FIG. 1 is a view of a holding device according to the invention mounted on an impregnation mandrel of a fiber texture winding machine;

FIGS. 2A, 2B, 2C and 2D illustrate the different steps of implementation of a resin injection method according to the invention by means of the holding device of FIG. 1.

### DETAILED DESCRIPTION OF ONE EMBODIMENT

The invention will be described below in the context of its application to the manufacture of a fan casing for an aeronautical gas turbine engine. The casing is made of composite material with fiber reinforcement densified by a matrix. The reinforcement is made of fibers, for example carbon, glass, aramid or ceramic fibers, and the matrix is made of polymer, for example epoxy, bismaleimide or polyimide polymer.

The invention applies to any type of winding machine whose function is to allow automated transfer of the fiber texture stored on a storage mandrel to an impregnation mandrel of the resin injection mold.

Briefly, such a winding machine comprises a frame supporting in particular the storage mandrel and the impregnation mandrel. The storage mandrel which receives the fiber texture is carried by a horizontal axis driven in rotation by an electric motor and along which it can be translated relative to the frame to perform an alignment of this mandrel on the impregnation mandrel during the winding of the fiber texture on the impregnation mandrel. The impregnation mandrel which is intended to receive in superimposed layers the fiber texture stored on the storage mandrel has an external surface whose profile corresponds to that of the inner surface of the casing to be produced and two side flanges whose profiles correspond to those of the outer clamps of the casing at its upstream and downstream ends in order to allow its mounting and its connection with other elements. However, it is possible in the case of an intermediate casing shroud (VCI) to have only one clamp. The impregnation mandrel is carried by a horizontal axis which is also parallel to the axis of rotation of the storage mandrel and just like it driven in rotation by an electric motor. A control unit connected to these two electric motors allows controlling and monitoring the rotational speed of each mandrel as well as all the operating parameters of the winding machine.

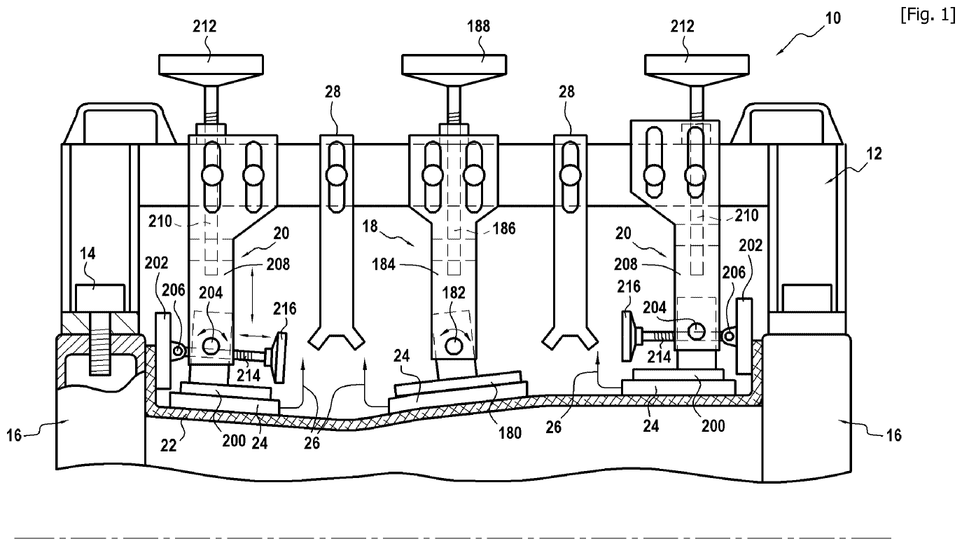

FIG. 1 shows an example of a removable holding device positioned at the start of winding at a predetermined angular position on the impregnation mandrel and ensuring the fastening of the free end of the fiber texture of the storage mandrel on the impregnation mandrel. At the end of winding, it is also used to hold the fiber texture on the impregnation mandrel before it is cut to its final length.

This removable holding device 10 comprises in particular a cross-member 12 forming a support whose both ends are fastened, for example by means of screws 14, on the side flanges of an impregnation mandrel 16. In the example illustrated, which cannot be limiting, the cross-member 12 supports three block holders; namely a central block holder 18 (but a configuration with two or even three or four block holders is also possible depending on the width of the mandrel) and two side block holders 20 (or even only one in the case of a VCI).

The central block holder 18, when it is unique as illustrated, is more specifically positioned substantially equidistant from the two side flanges of the impregnation mandrel 16. It comprises a front clamping block (or clamp 180) preferably carried by a pivot link 182 on a block holder 184 itself fastened on the cross-member 12 (but a rigid link of the slide type integrating a height adjustment and compaction function can also be envisaged, in particular for the flat or low slope areas). The central block holder 18 also comprises a screw-nut system composed of a worm screw 186 operable by a crank 188 and secured to the block holder 184. By pivoting the crank 188, it is thus possible to lower or raise the front clamping block 180 relative to the cross-member 12, and therefore to more or less clamp the block on the fiber texture layer 22.

Likewise, each side block holder 20 comprises a side clamping block 202 and also optionally a front clamping block 200 preferably carried respectively by a rigid link 206 and a pivot link 204, on a block holder 208 itself fastened on the cross-member 12 and a screw-nut system composed of a worm screw 210 operable by a clamping crank 212 and secured to the block holder 208 allows, when present, lowering or raising the front clamping block 200 relative to the cross-member 12, and therefore clamping more or less the block on the layer of fiber texture 22. The side clamping block 202 is also adjustable by means of a screw-nut system composed of a worm screw 214 secured to the block holder 208 and operable by a side clamping crank 216. By pivoting this crank 216, it is thus possible to laterally move the side clamping block 202 relative to the side flange of the impregnation mandrel 16, and therefore clamp more or less this side clamping block on the vertical side edge of the fiber texture layer 22 (as these screw-nut systems like any other similar means are able to exert this clamping force of the blocks, can of course be motorized).

In accordance with the invention, a heating pad 24 is advantageously interposed between each front block 180, 200 and the fiber texture layer 22 wound on the impregnation mandrel 16. The presence of this heating pad ensures a heating of the fiber texture at the end of winding, which has the effect of making it cardboard and thus ensuring better adhesion of the tackifier which is generally spread between the last two layers of this fiber texture.

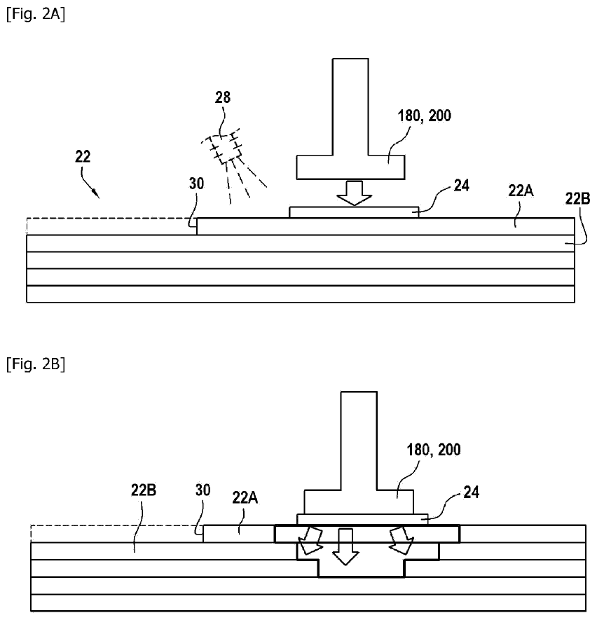

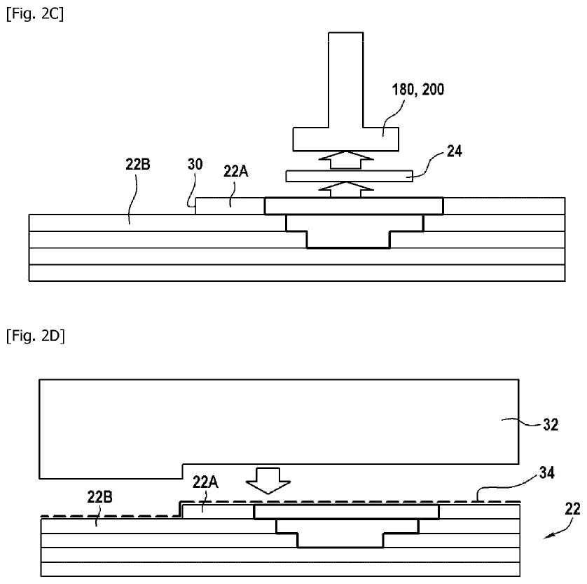

In conjunction with FIGS. 2A to 2D, the process of cutting the fiber texture and closing the resin injection mold at the end of winding by means of the improved holding device in accordance with the invention will now be described. The impregnation of the fiber texture can be carried out by the injection molding processes called RTM (Resin Transfer Molding) or by flexible injection called Polyflex™.

In FIG. 2A, the fiber texture is at the end of winding, the fifth and last layer 22A, in a final winding turn of the fiber texture on the impregnation mandrel 16, winding on the fourth layer 22B by defining an end-of-winding position 30 at the terminal end of the latter layer. Beforehand, to promote the adhesion of the last layer 22A on the penultimate layer 22B, a tackifier will have been advantageously sprayed on this penultimate layer. By actuating the cranks, the different front clamping blocks 180, 200 of the holding device are then lowered to hold the fiber texture during cutting, which has the consequence of bearing the heating pads 24 against the fiber texture 22.

Optionally and in order to immobilize this end of winding a little more, a thin layer of the impregnation resin (it is the same resin which will then be injected into the mold once closed) can be applied on the fiber texture 22 before the bearing of the clamping blocks 180, 200, 202 and the heating of the fiber texture by the heating pads 24. The percentage of the applied impregnation resin may represent less than 3% of the total impregnation resin injected into the mold. This thin layer of resin can be deposited automatically by spraying by means of a spraying module or sprayer 28 or manually by simple whitewash.

This spraying is particularly interesting in the case of the Polyflex™ molding process because the curing of the resin avoids any detachment and unwinding during the installation of the compaction membrane (necessary to maintain the pressure of the resin, it transmits the forces applied by a fluid present on the other side of the membrane) which is made with the holding device removed.

In this position and as illustrated FIG. 2B, the last layer 22A of the fiber texture is cut at the end-of-winding position 30 and the heating of the pads 24 is activated, for example via a dedicated electrical connection 26, causing, more particularly at the last two winding turns, a polymerization of the tackifier and/or of the applied resin, such as to ensure perfect drying of the fiber texture thus compacted.

In a following step illustrated in FIG. 2C, the blocks can be raised and the removed heating pads leaving a perfectly fixed fiber texture and whose end-of-winding position 30 of the last layer 22A has not moved, unlike the previous methods of the prior art where a slip from this position occurs even in the presence of tackifier between the last layers.

In a last step illustrated in FIG. 2D, the mold can then be closed and the resin injection can be performed. No cavity likely to create a resin-rich area then appears in the thus closed mold.

This closure can be preceded by the installation of the compaction membrane 34 used in the case of the Polyflex™ molding process. This membrane must of course be laid with care to avoid any detachment and partial unwinding of the fiber texture.

It will be noted that if reference has been made to a heating pad pressed against the fiber texture by the clamping blocks, it can also be envisaged that heating pads 24 and front clamping blocks 180, 200 form one and the same part using front clamping blocks with heating beads.

1. A method for injecting an impregnation resin for the manufacture of a revolution part made of composite material wherein several clamping blocks are bearing on a fiber texture wound on an impregnation mandrel forming an injection mold for its holding during the cutting of the last layer of the fiber texture in an end of winding position wherein the fiber texture is heated before the removal of the clamping blocks and the closing of the mold to inject the impregnation resin therein.

2. The method according to claim 1, wherein a thin layer of the impregnation resin is applied on the fiber texture before the bearing of the clamping blocks and the heating of the fiber texture.

3. The method according to claim 2, wherein the thin layer of the impregnation resin is applied by spraying or whitewash.

4. The method according to claim 2, wherein the percentage of applied impregnation resin represents less than 3% of the total of the impregnation resin injected into the mold.

5. The method according to claim 1, wherein the closing of the mold is preceded by the installation of a compaction membrane.

6. A device for holding a fiber texture on an impregnation mandrel forming an injection mold, comprising:
a cross member forming a support, each end of which is intended to be fastened on one of the side flanges of the impregnation mandrel;
at least one central block holder mounted on the cross member and provided with a front clamping block and at least one side block holder mounted on the cross member and provided with at least one side clamping block; wherein it further comprises:
a heating pad interposed between each front clamping block and the layer of fiber texture wound on the impregnation mandrel; and
means for exerting a clamping force of the front clamping blocks on the layer of fiber texture wound on the impregnation mandrel via the heating pads.

7. The device according to claim 6, wherein it further comprises a spraying module intended to spray a thin layer of the impregnation resin onto the fiber texture, before the bearing of the clamping blocks and the heating of the fiber texture by the heating pads.

8. The device according to claim 6, wherein the heating pads and the front clamping blocks form one and the same part.

9. The device according to claim 6, wherein it further comprises a compaction membrane disposed on the layer of fiber texture before the closing of the mold.

10. A machine for winding a fiber texture on an impregnation mandrel, comprising:
an impregnation mandrel on which the fiber texture stored on a storage mandrel is intended to be wound in superimposed layers; and
at least one device for holding the fiber texture on the impregnation mandrel according to claim 6.
